(19) United States
(12) Patent Application Publication
(10) Pub. No.: US 2009/0146096 A1
(43) Pub. Date: Jun. 11, 2009

(54) APPARATUS AND METHODS TO ALIGN A CLOSURE MEMBER AND A VALVE STEM

(76) Inventors: Lonnie Oscar Davies, JR., Newton, IA (US); David Westwater, Albion, IA (US); Aaron Perrault, Marshalltown, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/952,696

(22) Filed: Dec. 7, 2007

(51) Int. Cl. F16K 1/00

(52) U.S. Cl. 251/333

(57) ABSTRACT

Apparatus to align a closure member and valve stem for use with valves are described. An example valve includes a stem and a closure member having a first aperture to receive at least a portion of the stem. The example valve further includes a positioning member that has a first portion and a second portion. The first portion has a first cross-section and the second portion has a second cross-section that is greater than the first cross-section and an area between the first portion and the second portion forms a positioning surface to engage the first aperture of the closure member to align the stem and the closure member. A fastening member couples the stem to the closure member.

### FIELD OF THE DISCLOSURE

This disclosure relates generally to control valves and, more particularly, to apparatus and methods to align a closure member and a valve stem.

### BACKGROUND

Control valves (e.g., linear valves, rotary valves, etc.) are commonly used in process control systems to control the flow of process fluids. Linear valves such as, for example, a gate valve, a globe valve, a diaphragm valve, a pinch valve, etc. typically have a valve stem (e.g., a sliding stem) that drives a closure member (e.g., a valve plug) disposed in a path of fluid between an open position and a closed position.

In some known control valves, a valve stem is threadably coupled to a closure member (e.g., a valve plug) via threads at a threaded opening of the closure member such that the valve stem is oriented substantially perpendicular to the closure member. In other known control valves, the valve stem is welded to the closure member. In yet other known control valves, the valve stem and the closure member are integrally formed (e.g., via injection molding) as a substantially unitary or single piece. However, manufacturing tolerances, installation misalignment and other factors, can cause misalignment (e.g., an axial misalignment and/or a concentric misalignment) between the valve stem and the closure member when coupling the valve stem to the closure member via threads, welding, and/or integrally forming (e.g., via injection molding) the stem with the closure member as a substantially unitary or single structure.

In operation, a misalignment of the valve stem and the closure member can cause seat leakage (i.e., undesired leakage passing through the valve when the valve is in the fully closed position due to a misalignment of the closure member and the valve seat). Furthermore, the misalignment of the valve stem and the closure member can cause the valve stem to slide against an inner bore of a packing system causing packing distortion and/or wear, which may cause leakage of process fluid through the pressure barrier. Although a packing system can typically be field serviced (e.g., removed and replaced), such service usually requires time consuming and/or difficult removal of a valve actuator and/or other components from the valve.

### SUMMARY

An example valve described herein includes a stem and a closure member having a first aperture to receive at least a portion of the stem. The valve further includes a positioning member having a first portion and a second portion. The first portion has a first cross-section and the second portion has a second cross-section that is greater than the first cross-section. An area between the first portion and the second portion forms a positioning surface to engage the first aperture of the closure member to align the stem and the closure member. A fastening member couples the stem to the closure member.

In another example, a closure member and valve stem for use in a valve includes a first aperture of the closure member to receive at least a portion of the valve stem. A shoulder disposed along a length of the valve stem or a positioning member engages the first aperture of the closure member. Engagement of the shoulder or the positioning member with the first aperture substantially axially aligns the valve stem and the closure member. A fastening member couples the stem to the closure member.

### BRIEF DESCRIPTION OF THE DRAWINGS

FIG. 1A is a cross-sectional view of a known example control valve.

FIG. 1B illustrates an enlarged view of the example packing system of FIG. 1A.

FIG. 2A is an exploded cross-sectional view of an example closure member and valve stem assembly described herein.

FIG. 2B depicts an alternative example positioning member.

FIG. 3A is an assembly view of an example closure member and valve stem assembly implemented with the alternative example positioning member of FIG. 2B.

FIG. 3B is an enlarged cross-sectional view of a portion of the example closure member and valve stem assembly of FIG. 3A.

FIG. 4 illustrates an alternative embodiment of an example closure member and valve stem assembly described herein.

### DETAILED DESCRIPTION

In general, an example closure member (e.g., a plug) and valve stem assembly described herein may be used with valves having a sliding stem such as, for example, control valves, throttling valves, on/off valves, etc. An example closure member and valve stem assembly includes a valve stem coupled to a closure member via a fastening member. In particular, a positioning member engages an aperture of the closure member to align the valve stem and the closure member when coupled together with the fastening member.

The positioning member includes a first portion having a first cross-section and a second portion having a second cross-section that is larger than the first cross-section. An area between the first portion and the second portion forms a positioning surface that engages an aperture of the closure member to align the valve stem and the closure member. In this manner, the example closure member and valve stem assemblies described herein can achieve both axial and concentric alignment of a valve stem and a closure member. Axial and concentric alignment of a valve stem and a closure member may reduce packing distortion and/or wear (i.e., minimize valve stem contact against an inner bore of the packing) and provide a substantial alignment of the closure member and the valve seat to provide a tight seal (i.e., prevent seat leakage). Furthermore, the example closure member and valve stem assembly described herein also facilitates disassembly of the valve stem and closure member for field repair or replacement of the valve stem and/or closure member. Additionally, the example closure member and valve stem assembly described herein may be provided as a factory installed option or, alternatively, can be retrofit to existing valves in the field.

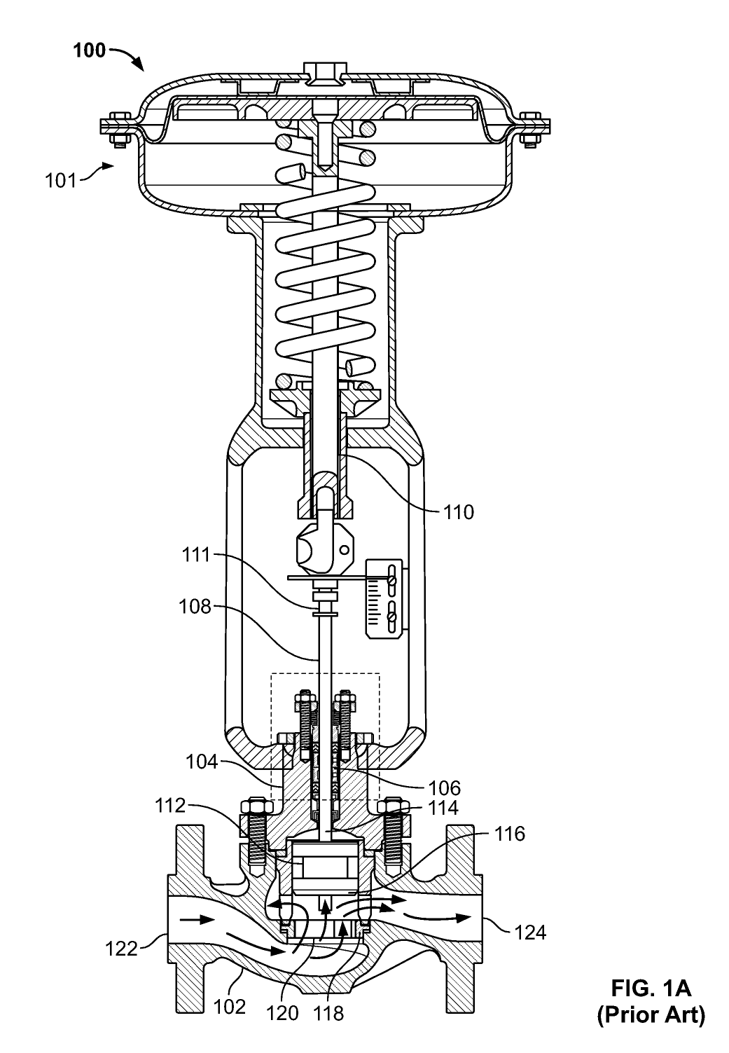

Before describing the example closure member and valve stem assembly, a brief discussion of a known pneumatically actuated control valve is first provided in connection with FIG. 1A. The control valve 100 shown in FIG. 1A includes an actuator 101 operatively coupled to a valve body 102. A bonnet 104 houses a packing system 106 and a valve stem 108. The valve stem 108 is coupled to an actuator stem 110 at an upper end 111 of the valve stem 108 and a closure member 112 (e.g., a valve plug) at a lower end 114 of the valve stem 108. The valve plug 112 includes a seating surface 116 that cooperates with a valve seat 118 of an orifice 120 to control the port area through which fluid may flow from an inlet passage 122 to an outlet passage 124. Thus, the fluid flow permitted through the control valve 100 is controlled by the position of the valve stem 108 and the position of the valve plug 112 relative to the valve seat 118 of the orifice 120. The position of the valve stem 108 may be varied from a closed position at which the valve plug 112 is in sealing engagement with the valve seat 118 (i.e., to restrict the flow of fluid through the valve) to a fully open or maximum flow rate position at which the valve plug 112 is away from the valve seat 118 (i.e., to allow the flow of fluid through the valve).

FIG. 1B depicts an enlarged cross-sectional view of the packing system 106 illustrated in FIG. 1A. A packing system typically provides a seal to prevent leakage of process fluid and/or protects the environment against the emission of hazardous or polluting fluids. As shown in FIG. 1B, the packing system 106 includes a flange 150 coupled to the bonnet 104 via fasteners 152 (e.g., stud screws). A packing material 154 surrounds the valve stem 108 and is typically compressed by a packing follower 156 to ensure that an inner bore 157 of the packing material 154 is sealed against the valve stem 108 and that an outer surface 159 of the packing material 154 is sealed against an opening 158 in the bonnet 104. A spring 160 may be positioned between the packing follower 156 and the flange 150. The fasteners 152 may be used to adjustably drive or urge the spring 160 against the packing follower 156 which, in turn, compresses the packing material 154 to provide a seal and prevent undesired leakage of process fluid past the valve stem 108.

As described above, the valve stem 108 and the valve plug 112 may be integrally formed as a single piece or structure, or may be formed in separate pieces for connection by common fastening methods. Also, as discussed above, rigidly coupling a valve stem to a closure member can lead to axial and concentric misalignment of valve stem and closure member, which may cause undesired leakage (e.g., due to misalignment of a closure member and a valve seat) and/or packing distortion or wear (i.e., a misaligned valve stem sliding against an inner bore of a packing material).

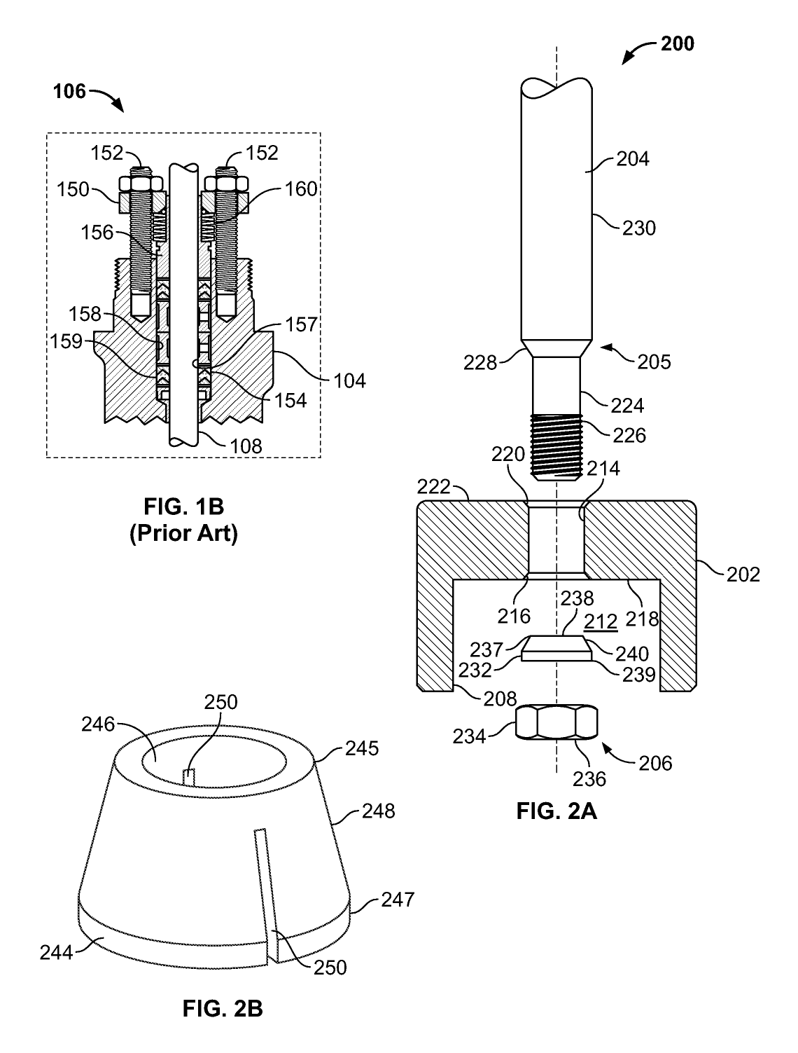

The example closure member and valve stem assemblies 200, 300, and 400 illustrated in FIGS. 2A, 3A, and 4 may be provided as a factory installed option or, alternatively, can be retrofit to existing valves in the field, such as, for example, the example control valve 100 of FIG. 1A. The description of those components of FIGS. 2A, 3A, and 4 similar or identical to those of FIG. 1A is not repeated and the interested reader may refer to the description of FIG. 1A for those components.

FIG. 2A illustrates an exploded view of an example closure member and valve stem assembly 200 described herein. The example assembly 200 includes a closure member 202 coupled to a valve stem 204 via a fastening member 206. FIG. 2A depicts the closure member 202 as a valve plug. However, in other example implementations, the closure member 202 may be a disk, or any other structure to vary the flow of fluid through a valve. The example closure member 202 is a cylindrical member having an inner wall portion 208 defining a cavity 212. The closure member 202 includes an opening or aperture 214 to receive the valve stem 204 and may include a first opening 216 at a first end 218 of the closure member 202 and a second opening 220 at a second end 222 of the closure member 202. The first and the second openings 216 and 220 are substantially coaxially aligned with the aperture 214. As illustrated in FIG. 2A, the first and second openings 216 and 220 have a tapered surface. However, in other example implementations, the first and second openings 216 and 220 can be, for example, counterbores, rectangular surfaces, stepped-surfaces, etc., or any combination thereof. The closure member 202 can be made of steel, aluminum, or any other suitable material(s), and may be formed via machining, injection molding, or any other suitable process(es).

The valve stem 204 can include a positioning member 205, which may be integrally formed with the valve stem 204 as a substantially unitary piece or structure. To integrally form the positioning member 205, the valve stem 204 can include a first portion 224 having a first cross section, a segment of which may be a threaded segment 226, and a second portion 230 having a second cross-section that is greater than the first cross-section of the first portion 224. In the illustrated example, the first and second cross-sections are circular or substantially circular. However, in other example implementations, the first and second cross-sections can be polygonal (e.g., square, rectangular, etc.).

As depicted in the illustrated example, an area between the first portion 224 and the second portion 230 forms a positioning surface 228. In the example illustration, the positioning surface 228 is a shoulder that is formed along a length of the valve stem 204 that transitions the second portion 230 to the first portion 224. In the illustrated example, the shoulder 228 is a tapered surface, though a flat surface, a step-like surface, a rectangularly-shaped surface, or any other shape could be formed instead. When the valve stem 204 is coupled to the closure member 202, the shoulder 228 engages the second opening 220 of the closure member 202 to concentrically and axially align the valve stem 204 with the closure member 202.

Another example positioning member 232 is depicted as a tapered washer. The positioning member 232 has a first portion 237 having a first cross-section and a second portion 239 having a second cross-section that is greater than the first cross-section. The first and second cross-sections can be circular, square, rectangular, etc. An area between the first portion 237 and second portion 239 forms a positioning surface 240. In the illustrated example, the positioning surface 240 is depicted as a tapered surface that engages the first opening 216 when the fastening member 206 is fastened to the threaded portion 226 of the valve stem 204, thereby causing the valve stem 204 to concentrically and axially align with the closure member 202. Although the illustrated example shows a linearly tapered surface 240, any other shape such as, for example, a flat surface, a step-like surface, a curved surface, a rectangular surface, etc. may be used as well. The tapered washer 232 also includes an aperture 238 that slidably engages the valve stem 204.

The fastening member 206 couples the valve stem 204 to the closure member 202. As illustrated in FIG. 2A, the fastening member 206 is depicted as a nut 234 that includes a threaded aperture 236 to threadably engage the threaded portion 226 of the valve stem 204 to couple the valve stem 204 to the closure member 202. However, the example fastening member 206 is not limited to the illustrated example shown in FIG. 2A. In other example implementations, the valve stem 204 may include an aperture or hole through the first segment 224 to receive a fastening member such as, for example, a pin, a clip, etc. that couples the valve stem 204 to the closure member 202. In yet other example implementations, a fastening member such as, for example, a clamp, can be used to couple the valve stem 204 to the closure member 202.

FIG. 2B is yet another example of a positioning member that can be used with the valve stem and control member assembly 200 of FIG. 2A. In the illustrated example, a cleft positioning member 244 includes a cleft edge 250, which may in this or in other examples be any type of split, ridged, or guided edge, and/or a partially split, ridged, or guided edge, etc. In the illustrated example, the cleft edge 250 is a partially split or guided edge 250. Additionally or alternatively, the cleft positioning member 244 can include a plurality of axially disposed, partially split or guided edges 250 (e.g., 90 degrees apart, 120 degrees apart, etc.). In this manner, the cleft edge or edges 250 collapse (i.e., crush) around the non-threaded portion 224 of the valve stem 204 to engage and prevent the valve stem 204 from rotating due to vibration and/or other mechanical forces. In yet other example implementations, the cleft positioning member 244 may include a single split or guided edge extending through the positioning member 244.

The cleft positioning member 244 also includes an aperture 246 that slidably engages the valve stem 204. The cleft positioning member 244 has a first portion 245 having a first cross-section and a second portion 247 having a second cross-section that is larger than the first cross section. The area between the first and second portions 245 and 247 forms a positioning surface 248 that engages the first opening 216 of the closure member 202. In the illustrated example, the positioning surface 248 is depicted as a tapered surface. However, in other example implementations, the positioning surface 248 can be a stepped-surface, a polygonal-surface, etc. Similar to the positioning member 232 of FIG. 2A, the cleft positioning member 244 causes the valve stem 204 and the closure member 202 to concentrically and axially align when the valve stem 204 is coupled to the closure member 202 via the fastening member 206.

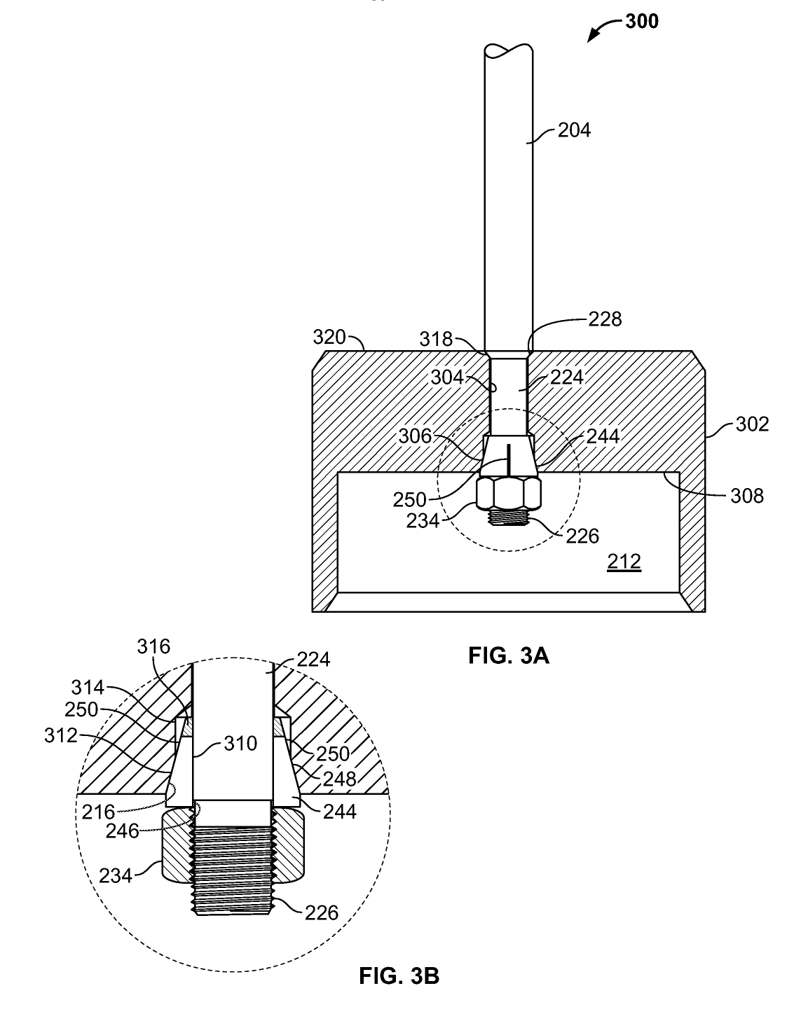

FIG. 3A illustrates an assembly view of an example closure member and valve stem assembly 300 having the valve stem 204 of FIG. 2A and a closure member 302 implemented with the cleft positioning member 244 of FIG. 2B. FIG. 3B illustrates an enlarged cross-sectional view of a portion of the example closure member and valve stem assembly 300 illustrated in FIG. 3A.

Referring to FIGS. 3A and 3B, when assembled, an aperture 304 of the closure member 302 receives the first portion 224 of the valve stem 204. The aperture 246 of the cleft positioning member 244 slidably engages the first portion 224 of the valve stem 204, and the positioning surface 248 of the cleft positioning member 244 engages a first opening 306 at a first end 308 of the closure member 302. As clearly shown in FIG. 3B, the cleft positioning member 244 slidably engages the non-threaded portion 224 of the valve stem 204 so that when the fastening member 234 is tightened to collapse the cleft positing member 244 around the valve stem 204, a surface 310 of the aperture 246 engages the non-threaded portion 224 of the valve stem 204 with a substantial contact surface area. In the illustrated example, the first opening 306 has a tapered portion 312 and a recess portion 314 (e.g., a counterbore) so that the cleft positioning member 244 can be positioned in the first opening 306 such that the cleft edge 250 contacts the tapered portion 312 of the first opening 306 below a non-split portion 316 of the cleft positioning member 244. In this manner, the cleft positioning member 244 collapses around the valve stem 204 to apply a relatively constant force to the non-threaded portion 224 of the valve stem 204 to provide a substantially tight fit and prevent rotational movement of the valve stem 204.

The closure member 302 may also include a second opening 318 at a second end 320 of the closure member 302. The first and the second openings 306 and 318 are substantially coaxially aligned with the aperture 304. As shown, each of the first and second openings 306 and 318 has a tapered surface. However, in other example implementations, the first and second openings 306 and 318 can be, for example, counterbores, stepped-surfaces, polygonal (e.g., rectangular) surfaces, etc., or any combination thereof. The closure member 302 can be made of steel, aluminum, or any other suitable material(s), and may be formed via machining, injection molding, or any other suitable process(es).

In the illustrated example, as the fastening member 234 is tightened, the positioning surface 228 of the positioning member 205 engages the second opening 318 and the positioning surface 248 of the cleft positioning member 244 engages the first opening 306 to cause the valve stem 204 to axially and concentrically align with the closure member 302. As described above, the cleft edge 250 collapses around the valve stem 204 to prevent the valve stem 204 from rotating due to vibration and/or other mechanical forces once the fastening member 234 has been tightened.

The shape of the positioning surfaces 240 or 248 can be substantially similar to the shape of the first openings 216 or 306 and/or the shape of the positioning surface 228 can be substantially similar to the shape of the second openings 220 or 318. For example, in the illustrated example, the angle of the tapered surface of the shoulder 228 is substantially similarly (i.e., is complementary) to the angle of the second opening 318, and the tapered surface 248 of the cleft positioning member 244 is angled substantially similar (i.e., is complementary) to the angle of the first opening 306. In this manner, the valve stem 204 is fastened to the closure member 302, and the positioning surfaces 228 and 248 of the positioning member 205 and the cleft positioning member 244 engage the first and the second openings 306 and 318 to enable alignment of the valve stem 204 and the closure member 302. In other example implementations, only a portion of the positioning surfaces 240 or 248 of the positioning members 232 or 244 engage a portion of the first openings 216 or 306 and/or the positioning surface 228 of the positioning member 205 engages a portion of the second openings 220 or 318.

In yet other example implementations, the shapes of the positioning surfaces can be substantially dissimilar relative to the shapes of the first openings 216 or 306. For example, the angle of the positioning surfaces 240 or 248 can be angled differently relative to the angle of the first openings 216 or 306. Likewise, the angle of the positioning surface 228 (e.g., the angle of the tapered shoulder) can be angled differently relative to the angle of the second openings 220 or 318. In this manner, the dissimilarly shaped surfaces (e.g., differently tapered surfaces) can still mate or engage to achieve both axial and concentric alignment (i.e., alignment of the valve stem 204 and closure member 302).

In yet other example implementations, the size of the positioning member 205 can be different relative to the openings 220 or 318, and/or the size of the positioning members 232 or 244 can be different relative to the openings 216 or 306. For example, the positioning member 232 or the cleft positioning member 244 can have a different diameter than the first openings 216 or 306 and/or the diameter of the positioning member 205 can have a different diameter than that of the second openings 220 or 318. Regardless of the differing diameters, the positioning members 232 or 244 may engage the first openings 216 or 306 and/or the positioning member 205 may engage the second openings 220 or 318 to align the valve stem 204 with the closure members 202 or 302. Such difference(s) in diameter(s) can be caused by, for example, manufacturing tolerances, wear and tear caused to the positioning member 232, the cleft positioning member 244, the first openings 216 or 306 of the closure member, etc.

Furthermore, the positioning surfaces 228, 240 and 248 can reduce misalignment caused during installation of the closure members 202 or 302 and the valve stem 204. If the closure members 202 or 302 are misaligned with the valve stem 204 during installation, the fastening member 234, when fastened or tightened, causes the positioning surfaces 240 or 248 to engage the surface of the first openings 216 or 306 and/or the positioning surface 228 to engage the surface of the second openings 220 or 318 to cause the valve stem 204 and the closure members 202 or 302 to align axially and concentrically.

Unlike known rigidly coupled valve stems and closure members, the positioning members 205, 232 and 244 engage with respective first and second openings 216 or 306 and 220 or 318 to cause the valve stem 204 and the closure members 202 or 302 to align both axially and concentrically, thereby substantially reducing or eliminating misalignment between the valve stem 204 and the closure members 202 or 302. The positioning surfaces 228, 240 and 248 substantially reduce or eliminate misalignment caused by manufacturing tolerances, installation misalignment, misalignment caused by varying diameters of the positioning members 205, 240 or 244, the valve stem 204, the closure members 202 or 302, etc.

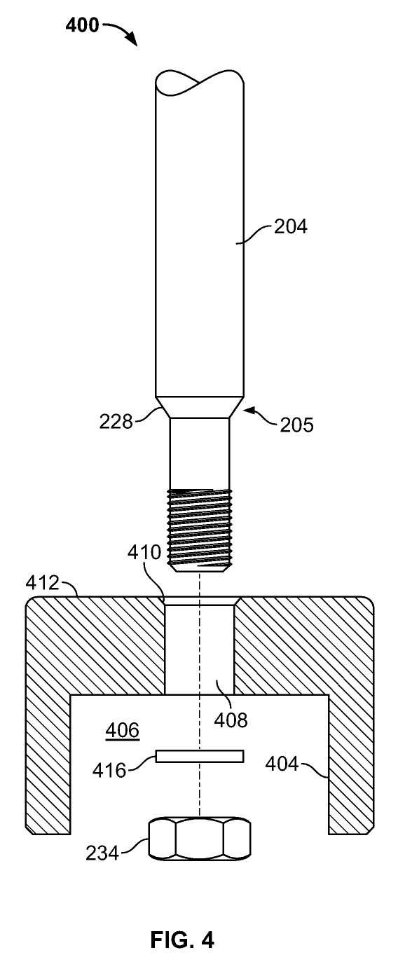

FIG. 4 illustrates an alternative embodiment of an example valve stem and closure member assembly 400 having the valve stem 204 of FIG. 2A and a closure member 402, but configured without the positioning members 240 or 248 of FIGS. 2A and 3A. In this configuration, the closure member 402 is a cylindrical member having an inner wall portion 404 defining a cavity 406. The closure member 402 can be made of steel, aluminum, or any other suitable material(s), and may be formed via machining, injection molding, or any other suitable process(es).

The closure member 402 includes an aperture 408 to receive the valve stem 204 and may include an opening 410 (e.g., a tapered opening) at a first end 412 of the closure member 202 to engage the positioning surface 228 of the positioning member 205 when the valve stem 204 is coupled to the closure member 402. In this manner, engagement of the positioning surface 228 and the opening 410 concentrically and axially aligns the valve stem 204 with the closure member 402. The opening 410 is substantially coaxially aligned with the aperture 408. In the illustrated example, the opening 410 forms a tapered surface that engages the tapered surface of the shoulder 228 when coupled to the closure member 402. In other example implementations, the opening 410 can be, for example, a counterbore, a stepped-surface, a rectangularly shaped surface, etc., or any combination thereof and/or any other suitable shape to coaxially and concentrically align the valve stem 204 and closure member 402. The fastening member 234 couples the valve stem 204 to the closure member 402. Additionally or alternatively, in some example implementations, a washer 416 can be used with the fastening member 232.

Referring to FIGS. 2A, 3A, and 4, in operation, the valve stem 204 is operatively coupled to an actuator such that displacement of the actuator causes the valve stem 204 to move in a linear path. The actuator can be any actuator such as, for example, the example the actuator 101 of FIG. 1A, a diaphragm actuator, a piston actuator, a hydraulic actuator, an electrical actuator, or any other suitable actuator. The actuator causes the valve stem 204 and, thus, the closure members 202, 302, or 402 to move toward and/or engage a valve seat (e.g., the valve seat 118 of FIG. 1A) to restrict fluid flowing through a control valve (e.g., the control valve 100 of FIG. 1A). The axially and concentrically aligned valve stem and closure member assemblies 200, 300, or 400 enable the closure members 202, 302, or 402 to engage the valve seat 118 to provide a substantially tight seal (i.e., to prevent seat leakage). Furthermore, the axially and concentrically aligned valve stem and closure member assemblies 200, 300, or 400 can reduce and/or minimize packing distortion and wear within a packing system (e.g., the packing system 106 of FIG. 1A), which reduces leakage of process fluid past the valve stem 204.

The example closure member and valve stem assemblies 200, 300, or 400 described herein advantageously maintain the orientation of the valve stem substantially perpendicular to the closure member to axially and concentrically align the valve stem and the closure member when assembled. In the illustrated examples, the positioning surfaces 228, 240, or 248 of the positioning members 205, 232, or 240 causes the valve stem 204 to axially and coaxially align with the closure members 202, 302, or 402. Engagement of the tapered surfaces 228, 240 or 248 cause the closure members 202, 302, or 402 and the valve stem 204 to align despite manufacturing tolerance variation and/or when installation misalignment between the closure member and valve stem occurs. The axial and concentric alignment, in turn, enables the closure members 202, 302, or 402 to properly align with a valve seat to provide a substantially tight seal to restrict or prevent the flow of process fluid through the orifice when the valve is in the fully closed position. Furthermore, the axial and concentric alignment minimizes the sliding movement of a valve stem against the inner bore of a packing, thereby reducing packing distortion and/or wear of the packing material.

Although certain methods and apparatus have been described herein, the scope of coverage of this patent is not limited thereto. To the contrary, this patent covers all methods and apparatus fairly falling within the scope of the appended claims either literally or under the doctrine of equivalents.

What is claimed is:

1. A valve, comprising:
a stem;
a closure member having a first aperture to receive at least a portion of the stem;
a positioning member having a first portion and a second portion, wherein the first portion has a first cross-section and the second portion has a second cross-section that is greater than the first cross-section, and wherein an area between the first portion and the second portion forms a positioning surface to engage the first aperture of the closure member to align the stem and the closure member; and
a fastening member to couple the stem to the closure member.

2. An apparatus as defined in claim 1, wherein each of the first and second portions has a substantially circular cross-section.

3. An apparatus as defined in claim 1, wherein the positioning surface of the positioning member comprises a tapered surface.

4. An apparatus as defined in claim 3, wherein the tapered surface engages a first tapered aperture of the closure member to align the stem and the closure member.

5. An apparatus as defined in claim 4, wherein a shape of the tapered surface of the positioning member and a shape of the first tapered aperture are complementary.

6. An apparatus as defined in claim 4, wherein a shape of the tapered surface of the positioning member and a shape of the first tapered aperture are different.

7. An apparatus as defined in claim 1, wherein the positioning member comprises a shoulder formed along a length of the stem.

8. An apparatus as defined in claim 7, wherein the shoulder comprises a tapered surface.

9. An apparatus as defined in claim 8, wherein the tapered surface engages a first tapered aperture of the closure member to align the stem and the closure member.

10. An apparatus as defined in claim 1, wherein the positioning member comprises a tapered washer.

11. An apparatus as defined in claim 10, wherein the tapered washer comprises a split tapered washer.

12. An apparatus as defined in claim 10, wherein the tapered washer further comprises a plurality of axially disposed partial cleft edges.

13. An apparatus as defined in claim 10, wherein the tapered washer engages a first tapered aperture of the closure member to align the stem and the closure member.

14. An apparatus as defined in claim 1, wherein the closure member further comprises a first tapered opening at a first end of the first aperture and a second tapered opening at a second end of the first aperture.

15. An apparatus as defined in claim 14, wherein the positioning member engages the first tapered opening and a second positioning member engages the second tapered opening.

16. An apparatus as defined in claim 1, wherein the closure member comprises a valve plug.

17. An apparatus as defined in claim 1, wherein the fastening member threadably engages the stem.

18. An apparatus as defined in claim 17, wherein the fastening member comprises a nut.

19. An apparatus as defined in claim 1, wherein at least a portion of the stem is threaded.

20. An apparatus as defined in claim 1, wherein the valve stem and the closure member are to substantially axially and concentrically align.

21. Apparatus for use in a valve, comprising:
a valve stem and a closure member having a first aperture to receive at least a portion of the valve stem;
a shoulder disposed along a length of the stem or a positioning member to engage the first aperture of the closure member, wherein engagement of the shoulder or the positioning member with the first aperture substantially axially aligns the valve stem and the closure member; and
a fastening member to couple the stem to the closure member.

22. Apparatus as defined in claim 21, wherein the closure member further comprises a first tapered opening at a first end of the first aperture and a second tapered opening at a second end of the first aperture.

23. Apparatus as defined in claim 22, wherein the shoulder of the valve stem comprises a tapered surface to engage the first tapered opening of the first aperture.

24. Apparatus as defined in claim 22, wherein the positioning member comprises a tapered washer to engage the second tapered opening of the first aperture.

25. Apparatus as defined in claim 24, wherein the tapered washer further comprises a plurality of axially disposed partial cleft edges.

26. Apparatus as defined in claim 21, wherein the fastening member comprises a nut.
